(19) United States
(12) Patent Application Publication
(10) Pub. No.: US 2011/0247995 A1
(43) Pub. Date: Oct. 13, 2011

(54) DRY ETCHING METHOD AND DRY ETCHING APPARATUS

(75) Inventors: Shuji TAKAHASHI, Kanagawa-ken (JP); Haruo SHINDO, Hiratsuka-shi (JP)

(73) Assignees: TOKAI UNIVERSITY EDUCATIONAL SYSTEM, Tokyo (JP); FUJIFILM CORPORATION, Tokyo (JP)

(21) Appl. No.: 13/084,854

(22) Filed: Apr. 12, 2011

(30) Foreign Application Priority Data
Apr. 13, 2010 (JP) 2010-092290

(51) Int. Cl. C23F 1/00; C23F 1/08; H05H 1/24

(52) U.S. Cl. 216/22; 216/67; 156/345.33

(57) ABSTRACT

A dry etching method includes the steps of: supplying process gas to an interior of a vacuum vessel and supplying high-frequency power for plasma generation to an electrode of a plasma generation unit disposed in the vacuum vessel so as to generate plasma; and applying a high-frequency bias voltage to a substrate which is a member to be etched so as to carry out etching of the substrate, wherein the etching is carried out while applying the high-frequency bias voltage in which a self-bias voltage Vdc of a substrate bias voltage is not less than 0 Volts, by adopting a composition using a high-frequency power source for bias which is transformer-coupled to the substrate and a direct current power source for bias which is connected in series to a secondary side of a transformer so as to apply the substrate bias voltage in which a high-frequency voltage and a direct current voltage are superimposed, to the substrate from these power sources via the transformer.

### BACKGROUND OF THE INVENTION

1. Field of the Invention

The present invention relates to a dry etching method and a dry etching apparatus, and more particularly, to dry etching technology suitable for processing etching resistant materials, such as ferroelectric material and precious metals.

2. Description of the Related Art

According to a conventional dry etching method, a high-density plasma is generated and etching is performed mainly using positive ions by applying a negative bias to a substrate. Since an etching resistant material, such as ferroelectric material, is non-volatile and hard to etch, then the etching rate is slow and productivity is low. Furthermore, due to problems such as adherence of reaction products, reattachment of processed material, and the like, there are cases where the processed cross-section has a tapered shape, product adheres to the processed side faces, and so on.

Japanese Patent No. 2845163 discloses a composition for pulse modulation of a high-frequency electric field for discharge in response to the issue of the difficulty of performing high-speed anisotropic etching while simultaneously suppressing device damage caused by accumulation of charge on a substrate surface in a microwave plasma etching apparatus. More specifically, Japanese Patent No. 2845163 proposes a composition in which a pulse of a plasma generating high-frequency wave is modulated with a pulse halt time range of 10 to 100 μsec, and a low-frequency bias of not greater than 600 kHz is applied to the substrate side.

By using a pulse-modulated plasma to increase the negative ion density in the plasma and applying a low-frequency bias which the ions can follow, then positive ions and negative ions are injected alternately into the substrate and the accumulation of change is suppressed.

Japanese Patent Application Publication No. 9-162169 proposes a plasma processing method and a plasma processing apparatus which prevent accumulation of charge (charging phenomenon) on the surface of a sample, while actively utilizing the negative ions to achieve high-speed processing. According to Japanese Patent Application Publication No. 9-162169, a plasma containing a relatively large amount of negative ions is generated inside a first plasma generation chamber which is set to a relatively high pressure environment, a plasma containing a relatively large amount of positive ions is generated inside a second plasma generation chamber which is set to a relatively low pressure environment, the negative ions and the positive ions are introduced into a plasma processing chamber, and plasma processing is carried out by applying a high-frequency alternating bias voltage to the sample described above (substrate). Moreover, in Japanese Patent Application Publication No. 9-162169, a composition using a high-frequency transformer is disclosed as a device for applying an alternating bias voltage.

In this way, Japanese Patent Application Publication No. 9-162169 employs a composition in which an ion attracting voltage is changed alternately at high frequency while maintaining the substrate potential at ground potential using a transformer for high-frequency application to a sample substrate (see FIG. 1 and FIG. 4 in Japanese Patent Application Publication No. 9-162169), and therefore it is possible to attract the negative ions more efficiently compared to a capacitor coupled bias method.

Japanese Patent Application Publication No. 2007-96256 proposes a plasma processing apparatus and a plasma processing method whereby surface wave downstream negative ions can be generated in a radio frequency band, with the aim of improving the etching rate and suppressing damage to a processing object. According to Japanese Patent Application Publication No. 2007-96256, a structure is adopted in which an annular power supply unit is attached to the outer circumferential surface of a round cylindrical body having relative permittivity of not less than 40 and not greater than 200, and the mode of installation of the annular power supply unit is such that the whole of the annular power supply unit is disposed to one end side (for example, the upper half side) of the center of the round cylindrical body in the lengthwise direction thereof.

However, the pulse-modulated plasma in the technology described in Japanese Patent No. 2845163 generates negative ions during an off period by repeating on/off switching of the plasma, and therefore the negative ion generation time is short compared to continuous discharge. For example, if the duty ratio is 50%, then this is half the time of the continuous discharge time, and the production efficiency of the negative ions is poor. Furthermore, although negative ions are injected into a substrate by using a low-frequency bias, this method simply injects positive and negative ions alternately. In order to achieve high-speed processing, it is necessary to use the reaction of the negative ions effectively. However, since the composition in Japanese Patent No. 2845163 uses a capacitor coupling type matching box for the substrate electrode, then it is not possible to control the DC bias voltage Vdc and the peak-to-peak potential difference Vpp independently. Therefore, it is difficult to control the voltage (bias) in such a manner that the negative ions are attracted effectively.

In the technology described in Japanese Patent Application Publication No. 9-162169, a plasma source for generating negative ions (negative ion generation chamber) and a plasma source for generating positive ions (positive ion generation chamber) are provided independently, and therefore the apparatus composition is complicated and the costs are high.

Furthermore, the composition described in Japanese Patent Application Publication No. 9-162169 uses a transformer-coupled bias, but applies only a high-frequency voltage (see FIG. 4 in Japanese Patent Application Publication No. 9-162169), and therefore it is not possible to control Vdc arbitrarily. In the case of Japanese Patent Application Publication No. 9-162169, Vdc is governed by the plasma potential and the value of Vpp. In order to perform etching at high speed under various different conditions relating to the material of the discharge tube (relative permittivity), the frequency of the high-frequency power for discharge which is applied, the material of the member to be etched, and so on, it is necessary to improve the control performance of the bias.

Japanese Patent Application Publication No. 2007-96256 specifies a relative permittivity of 40 to 200 for the discharge tube material, and cites K-140 (relative permittivity εᵣ=140) as a specific example. However, as described in Japanese Patent Application Publication No. 2007-96256, there is a possibility that a material having high relative permittivity has a high dielectric loss tangent and is liable to generate heat. In actual practice, a composition using a material having high relative permittivity is problematic in that the dielectric member breaks due to the heat generated by discharge over a prolonged period of time. More specifically, since the relative permittivity is high, then the value of tanδ is high, and therefore swelling, etc. of the dielectric body is produced by the generation of heat, leading to breakdown. Furthermore, Japanese Patent Application Publication No. 2007-96256 makes no specific disclosure regarding the method of applying the substrate bias.

### SUMMARY OF THE INVENTION

The present invention has been contrived in view of these circumstances, an object thereof being to provide a dry etching method and apparatus whereby the use efficiency of negative ions in plasma is improved and etching is possible at high speed, even with etching resistant materials. A further object of the invention is to provide a dry etching apparatus capable of simplifying the apparatus composition and reducing the cost.

The following modes of the invention are proposed in order to achieve an aforementioned object.

In order to attain an object described above, one aspect of the present invention is directed to a dry etching method comprising the steps of: supplying process gas to an interior of a vacuum vessel and supplying high-frequency power for plasma generation to an electrode to of a plasma generation unit disposed in the vacuum vessel so as to generate plasma; and applying a high-frequency bias voltage to a substrate which is a member to be etched so as to carry out etching of the substrate, wherein the etching is carried out while applying the high-frequency bias voltage in which a self-bias voltage Vdc of a substrate bias voltage is not less than 0 Volts, by adopting a composition using a high-frequency power source for bias which is transformer-coupled to the substrate and a direct current power source for bias which is connected in series to a secondary side of a transformer so as to apply the substrate bias voltage in which a high-frequency voltage and a direct current voltage are superimposed, to the substrate from these power sources via the transformer.

According to this aspect of the invention, it is possible to attract negative ions efficiently into a substrate, and high-speed etching is possible due to the reactivity of the negative ions.

Desirably, the plasma generation unit generates surface wave plasma.

According to this aspect of the invention, it is possible to create a down flow region in the vicinity of the plasma by using a surface wave plasma, and high-density generation of negative ions is possible. Compared to Japanese Patent No. 2845163, it is possible to generate negative ions all the time rather than only when the pulse is off.

Desirably, the process gas contains a halogen.

A mode where a gas containing a halogen is used as the process gas is desirable.

Desirably, the member to be etched is a ferroelectric body, a precious metal, or a magnetic body.

A mode where a ferroelectric body, a precious metal or a magnetic body, or the like, is processed as the object to be etched is especially desirable. With etching resistant materials of this kind, it is still possible to display beneficial effects brought about by the present invention more notably.

In order to attain an object described above, another aspect of the present invention is directed to a dry etching apparatus comprising: a vacuum vessel; a gas supply port for supplying process gas into the vacuum vessel; a plasma generation unit provided in the vacuum vessel; a high-frequency power source for plasma generation which supplies high-frequency power for plasma generation to an electrode of the plasma generation unit; a stage which is provided inside the vacuum vessel and holds a substrate which is a member to be etched; a high-frequency power source for bias which is transformer-coupled to the stage; and a direct current power source for bias which is connected in series to a secondary side of a transformer to which the high-frequency power source for bias is connected, wherein a substrate bias voltage in which a high-frequency voltage and a direct current voltage are superimposed is applied to the stage from the high-frequency power source for bias and the direct current power source for bias, via the transformer.

According to this aspect of the invention, it is possible to control the values Vdc and Vpp of the substrate bias voltage independently, and hence the control of the bias is improved and a positive bias can also be applied.

Desirably, a self-bias voltage Vdc of the substrate bias voltage is not less than 0 Volts.

In particular, by applying a bias where Vdc>0 V, it is possible to draw negative ions efficiently to a substrate and improvement in the etching rate can be achieved.

Desirably, the plasma generation unit generates surface wave plasma.

Desirably, a surface wave resonance density of the surface wave plasma generated by the plasma generation unit is not less than 4.1×10⁸ cm⁻³ and not greater than 1.0×10¹¹ cm⁻³.

Moreover, desirably, the surface wave resonance density is not less than 1.0×10⁹ cm⁻³ and not greater than 1.0×10¹¹ cm⁻³.

Desirably, a frequency of the high-frequency power for plasma generation is in a range of 27 MHz to 200 MHz.

From the viewpoint of the surface wave resonance density, by using a high-frequency wave of 13 MHz or above, and in particular 27 MHz or above, it is possible to generate a plasma of high density, even with a dielectric member having comparatively low relative permittivity.

Desirably, the plasma generation unit has a configuration in which the electrode is disposed on an outer circumferential portion of a dielectric member.

By supplying a high-frequency power for plasma generation from a high-frequency power source for plasma generation to an electrode installed on an outer circumferential portion of a dielectric member, a high-density plasma is generated inside the dielectric member.

Desirably, a relative permittivity of the dielectric member is in a range of 10 to 100.

According to this aspect of the invention, it is possible to avoid breakage of the dielectric body due to heat produced by discharge over a long period of time, and the reliability of the apparatus can be improved.

Desirably, the dielectric member is a round cylindrical discharge tube.

A mode of the plasma generation unit (plasma source) may employ, for example, a composition where an electrode is installed on the outer circumferential portion of a round cylindrical dielectric body.

Desirably, a plurality of said round cylindrical plasma generation units are provided in the vacuum vessel.

According to this aspect of the invention, it is possible to process a substrate of large size.

Desirably, the plurality of round cylindrical plasma generation units are provided extending in a direction perpendicular to the substrate.

Desirably, the plurality of round cylindrical plasma generation units are provided extending in a horizontal direction parallel to the substrate.

Desirably, a portion of the plurality of plasma generation units is provided extending in a direction perpendicular to the substrate and another portion of the plurality of plasma generation units is provided extending in a horizontal direction parallel to the substrate.

Desirably, an inner surface of the dielectric member is covered with a film containing a fluorine group.

According to this aspect of the invention, it is possible to suppress the generation of particles.

According to a dry etching method relating to the present invention, it is possible to draw negative ions efficiently into a substrate and high-speed etching is possible, even with etching resistant materials.

Furthermore, according to a dry etching apparatus relating to the present invention, it is possible to control the Vdc and Vpp values of the substrate bias voltage independently, and hence a suitable bias voltage capable of high-speed etching can be applied. Moreover, according to the present invention, it is possible to simplify the apparatus composition and reduce costs.

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is a schematic drawing of a dry etching apparatus relating to a first embodiment of the present invention;

FIGS. 2A and 2B are waveform diagrams showing an example of a voltage waveform of a substrate bias;

FIG. 3 is a waveform diagram showing an example of a substrate bias voltage waveform applied by a conventional capacitor coupling method;

FIG. 4 is a graph of experimental results of evaluating a relationship between the value of the self-bias voltage Vdc and the etching rate of PZT;

FIG. 5 is a graph of experimental results of evaluating a relationship between the material of a discharge tube and the etching rate;

FIG. 6 is a graph showing a relationship between the relative permittivity of a discharge tube and the surface wave resonance density;

FIG. 7 is a schematic drawing of a dry etching apparatus relating to a second embodiment of the present invention;

FIG. 8 is a plan diagram showing the dry etching apparatus in FIG. 7 as viewed from above;

FIGS. 9A and 9B are principal schematic drawings of a dry etching apparatus relating to a third embodiment of the present invention; and

FIG. 10 is a principal schematic drawing of a dry etching apparatus relating to a fourth embodiment of the present invention.

### DESCRIPTION OF THE PREFERRED EMBODIMENTS

### First Embodiment

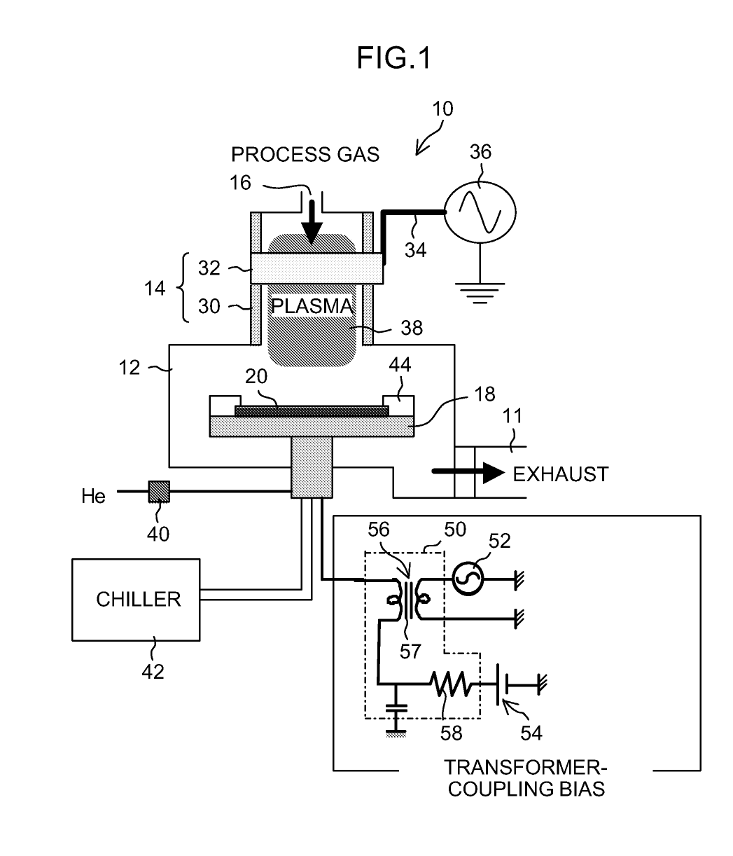

FIG. 1 is a schematic drawing of a dry etching apparatus relating to a first embodiment of the present invention. This dry etching apparatus 10 comprises a plasma source 14 (corresponding to a “plasma generation unit”) for generating a high-density plasma in a vacuum chamber 12 (corresponding to a “vacuum vessel”) equipped with an exhaust system (not illustrated) capable of evacuating gas via a gas exhaust path 11, and a process gas introduction port 16 (corresponding to a “gas supply channel”), and a stage 18 for holding and fixing a substrate 20 which is a member to be etched (processing object) is provided inside the vacuum chamber 12.

The plasma source 14 has a structure in which a band-shaped mesh electrode 32 is wrapped about a round cylindrical discharge tube 30 (corresponding to a “dielectric member”), and the band-shaped electrode 32 is connected to a high-frequency power source 36 (corresponding to a “high-frequency power source for plasma generation”) via a power supply wire 34. Provided that the surface wave resonance density which is described hereinafter satisfies prescribed conditions, there are no particular restrictions on the relative permittivity of the discharge tube 30 and the frequency of the high-frequency power source 36. For example, the discharge tube 30 is made of a dielectric body, and the relative permittivity thereof is desirably approximately 3 to 100. The high-frequency power source 36 desirably has a frequency of 13.56 MHz to 200 MHz.

A gas process introduction port 16 is provided in the upper part of the discharge tube 30, and process gas is introduced into the vacuum chamber 12 through the interior of the discharge tube 30 along the axis of the discharge tube 30. By supplying high-frequency power to the band-shaped electrode 32 while supplying the process gas, a high-density plasma 38 (surface wave plasma) is generated.

A stage 18 for processing the substrate 20 is arranged below the plasma 38. A substrate cooling system which uses an He cooling mechanism 40 or a cooling mechanism based on a chiller 42, or a combination of these, or the like (the coolant circulation flow channel structure, and the like, is not illustrated in the drawings) is incorporated with the stage 18. A mechanical chuck 44 or an electrostatic chuck for holding (fixing) the substrate 20 placed on the stage 18 is provided on the stage 18.

Furthermore, in order to control the substrate bias voltage applied to the substrate 20, a high-frequency power source 52 (corresponding to a “high-frequency power source for bias”) and a DC power source 54 (corresponding to a “direct current power source for bias”) are provided with the stage 18 in series via a transformer coupling type of matching box 50.

As shown in FIG. 1, a high-frequency power source 52 is connected to the primary winding side about a core 57 of a transformer 56, and a DC power source 54 is connected to the secondary winding via a resistor 58. By means of a composition of this kind, a substrate bias voltage formed by superimposed high-frequency voltage and DC voltage is applied to the substrate 20 on the stage 18, from the high-frequency power source 52 and the DC power source 54 via the transformer 56.

The high-frequency power source 52 for bias is desirably a relatively lower frequency power source with respect to the high-frequency power source 36 for plasma generation, and desirably a low-frequency power source is in the range of 100 kHz to 2 MHz for example. The output waveform of the high-frequency power source 52 is not limited to a sinusoidal waveform, and may be a square wave or triangular wave, or the like.

The output from the high-frequency power source 52 and the output from the DC power source 54 are controlled by a control circuit, which is not illustrated, and their respective outputs can be adjusted suitably. By adjusting the output of the high-frequency power source 52, it is possible to set the value of the peak-to-peak voltage (peak-to-peak potential difference) Vpp of the substrate bias voltage to a desired value. By adjusting the output of the DC power source 54, it is possible to set the value of the self-bias voltage Vdc of the substrate bias voltage to a desired value.

In this way, in a plasma apparatus (dry etching apparatus) which uses a surface wave plasma, by employing a bias application device of a transformer coupling type which incorporates the combination of a high-frequency power source 52 and a DC power source 54 in the substrate bias application unit, then it is possible to control the peak-to-peak voltage Vpp of the substrate bias voltage and the self-bias voltage Vdc, respectively and independently. Therefore, it is possible to apply a substrate bias voltage which has a Vdc value equal to or greater than 0 V, and hence a positive bias can be applied to the substrate 20.

By means of the composition described above, etching of the substrate 20 is carried out in the downstream region of the surface wave plasma.

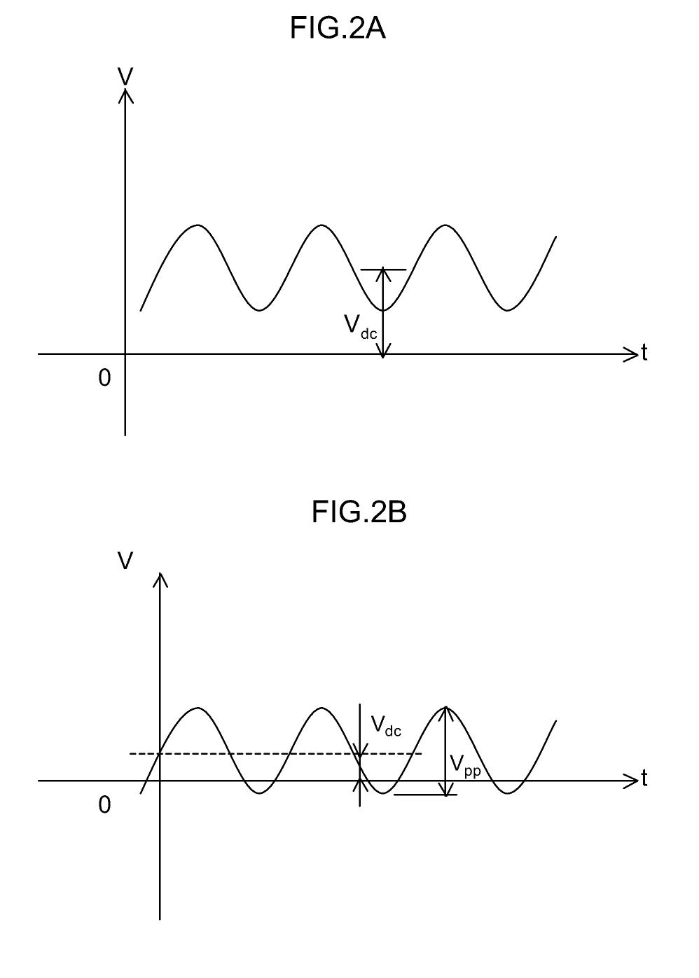

FIGS. 2A and 2B are graphs showing an example of the voltage waveform of a substrate bias applied to a substrate 20 on the stage 18. As shown in the drawing, by applying a substrate bias voltage which is controlled to a value where Vdc is a positive value, then it is possible to draw the negative ions in the plasma efficiently into the substrate 20, and responsiveness is improved. By this means, it is possible to achieve dramatic improvement in the etching rate, and high-speed etching of etching resistant material becomes possible. Vdc is ½ of the value of the peak-to-peak voltage Vpp.

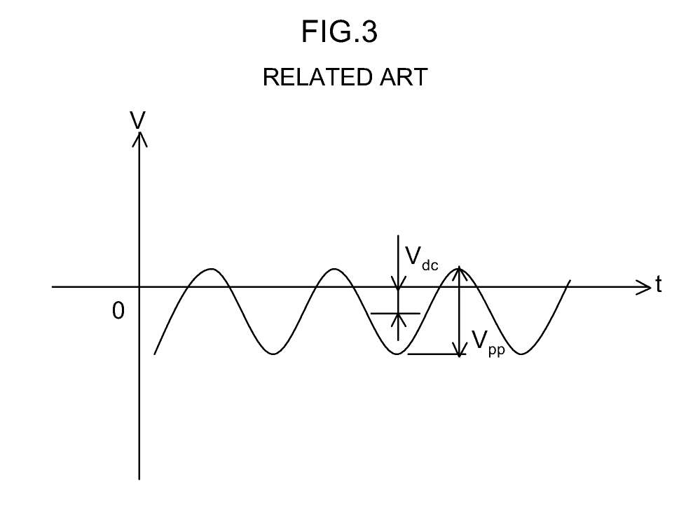

For the purposes of comparison, a voltage waveform of a substrate bias based on a conventional capacitor coupling method (for example, the mode in Japanese Patent No. 2845163) is illustrated in FIG. 3. As shown in FIG. 3, with a conventional capacitor coupling bias, Vdc is a negative value and the attraction of negative ions into the substrate is weak. In this respect, according to the embodiment of the present invention (illustrated in FIG. 1), it is possible to control Vdc to a positive value (see FIGS. 2A and 2B), and the use efficiency of the negative ions can be improved dramatically.

### Practical Example

### Example of Etching of Lead Zirconate Titanate (PZT)

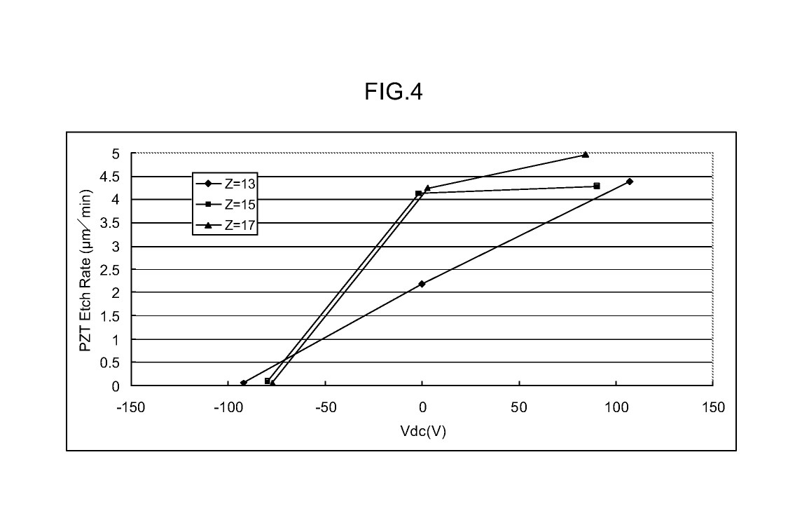

FIG. 4 shows the results of carrying out etching of PZT, which is a ferroelectric material, using the dry etching apparatus 10 illustrated in FIG. 1. FIG. 4 is a graph showing the relationship between the value of Vdc and the etching rate of the PZT. The horizontal axis indicates Vdc and the vertical axis indicates the etching rate. In this experiment, the DC component (Vdc) of the substrate bias was changed by controlling the output voltage of the DC power source 54, and the etching rate was evaluated under different conditions. Moreover, change in the etching rate was evaluated by altering the distance Z (the distance in the vertical direction in FIG. 1) between the substrate 20 placed on the stage 18 and the band-shaped electrode 32 of the discharge tube 30.

The substrate used for the substrate 20 to be etched was formed by forming a platinum (Pt) film with approximately 200 nm thick and a PZT film with approximately 5.0 μm thick by means of a sputtering method, on a substrate in which a silicon oxide film of 200 nm had been formed on a silicon substrate.

The discharge tube 30 used should have a relative permittivity of approximately 10 to 100, and in the practical example based on the experiment shown in FIG. 4, alumina having a relative permittivity of about 10 was used. The high-frequency power source 36 for surface wave plasma generation should have a frequency of approximately 13.56 MHz to 60 MHz, and in the present example, a frequency of 60 MHz was used and the output was 1000 W.

The etching gas should be a gas containing a halogen; for example, it is possible to use Cl₂ (chlorine), BCl₃ (boron tetrachloride), HBr (hydrogen bromide), SF₆ (sulfur hexafluoride), CF₄ (carbon tetrafluoride), CHF₃ (trifluoromethane), C₂F₆ (ethane hexafluoride), C₃F₈ (propane octofluoride), C₄F₆ (butadiene hexafluoride), C₄F₈ (cyclobutane octofluoride), C₅F₈ (octafluorocyclopentene), or the like, or a mixed gas of these, an inert gas such as argon, a mixed gas containing oxygen or nitrogen, or the like. The gas flow volume should be in a range between 1 and 1000 sccm. In the present example, SF₆ was used and the flow rate was set to 300 sccm. The unit of the flow rate (sccm) represents the Standard Cubic Centimeters per Minute which expresses the flow volume of gas flowing per minute in terms of the volume in a standard state (0° C., 1 atm (atmospheric pressure 1,013 hPa).

The degree of vacuum upon introducing gas is desirably in the range of 0.01 to 1000 Pa, and desirably in the range of 6.6 to 666 Pa. In the present practical example, the vacuum was set to 53 Pa.

The substrate bias used should have a high frequency of 100 kHz to 2 MHz, via the transformer coupling matching box 50 (see FIG. 1), and in the implementation of this experiment, a frequency of 400 kHz was used, the output was 20 W, and Vdc was controlled in the range from “−100 V” to “+120 V”. Furthermore, three modes were compared using different values for the distance Z between the substrate 20 and the band-shaped electrode 32, namely 13 cm, 15 cm and 17 cm.

As FIG. 4 clearly reveals, the etching rate became dramatically faster when Vdc was equal to or greater than 0 V (and in particular, when Vdc>0). Furthermore, as the distance Z between the substrate 20 and the band-shaped electrode 32 became greater, at 15 cm and then 17 cm compared to 13 cm, so the etching rate became faster.

This is because negative ions were produced in large quantities in the down flow region and a larger distance from the electrode means that the negative ions can be used actively for etching. However, if the distance is too great, then the etching rate declines. Hence, there is an optimal value of the etching rate, depending on the distance from the electrode.

FIG. 4 shows results for etching of PZT, and demonstrates the superior characteristics achieved when an embodiment of the present invention is applied, but the present invention is not limited to use with PZT only and is also effective with other etching resistant materials. As an etching resistant material, it is possible to use, apart from PZT, PZTN:Pb (ZR, Ti)Nb₂O₈, PLZT: (Pb, La), (ZR, Ti)O₃ or BST: (Ba, Sr)TiO₃, SRO: SrTiO₃, BTO: BaTiO₃, ZnO, ZrO₂, precious metals such as Pt, Ru, RuO₂, Ir, IrO₂, Au, or magnetic materials.

### Relationship Between Relative Permittivity of Discharge Tube and Etching Rate

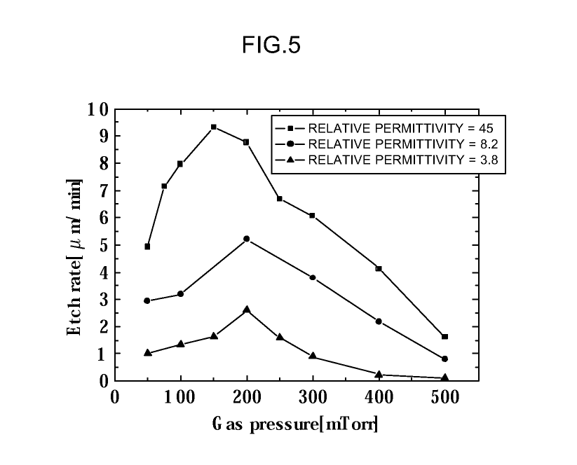

FIG. 5 shows the investigated relationship between the material of the discharge tube and the etching rate. FIG. 5 shows the result of comparing silicon etching rates for respective cases using a plurality of discharge tubes having different relative permittivities (here, three different tubes are given as an example). In this experiment, the silicon was etched respectively using a high-permittivity material having a relative permittivity of “45”, alumina having a relative permittivity of “8.2”, and quartz having a relative permittivity of “3.8”.

As regards the conditions for etching the silicon substrate, the high-frequency power source for surface wave plasma generation should have a frequency of approximately 13.56 MHz to 60 MHz, and in the implementation of this experiment, a frequency of 60 MHz was used and the output was 150 W.

The etching gas should be a halogen gas, and for example, it is possible to use Cl₂ (chlorine), BCl₃ (boron tetrachloride), HBr (hydrogen bromide), SF₆ (sulfur hexafluoride), CF₄ (carbon tetrafluoride), CHF₃ (trifluoromethane), C₂F₆ (ethane hexafluoride), C₃F₈ (propane octofluoride), C₄F₆ (butadiene hexafluoride), C₄F₈ (cyclobutane octofluoride), C₅F₈ (octafluorocyclopentene), or the like, or a mixed gas of these, an inert gas such as argon, a mixed gas containing oxygen or nitrogen, or the like. In this experiment, the flow rate using SF₆ was set to 75 sccm; and the degree of vacuum in this case should be 6.6 to 666 Pa, and in this experiment, the degree of vacuum was set to 20 Pa.

The substrate bias used should have a high frequency of 100 kHz to 2 MHz, via the transformer coupling matching box 50 (see FIG. 1), and in the implementation of this experiment, a frequency of 400 kHz was used, the output was 10 W, and Vdc was controlled to 120V. Furthermore, the distance Z from the substrate 20 to the band-shaped electrode 32 of the discharge tube 30 was set to 15 cm.

As FIG. 5 clearly reveals, the high-permittivity discharge tube having a relative permittivity of 45 has a better silicon etching rate than the other discharge tubes. The main composition of the high-permittivity material used here (relative permittivity 45) is an oxide made of La, Al, Ca and Ti. As shown in FIG. 5, the higher the relative permittivity of the discharge tube when generating a high-frequency plasma at 60 MHz, the faster the etching rate. If the relative permittivity of the discharge tube 30 is low, such as in the case of quartz, for instance, then the etching rate is not very high. It is desirable to use a discharge tube made of a material having a relative permittivity of at least that of alumina (relative permittivity 8.2) or above.

On the other hand, if using a discharge tube having a relative permittivity of 100 or above, the value of the dielectric dissipation factor is high, breakage due to generation of heat occurs, and therefore from the viewpoint of reliability, a discharge tube having a relative permittivity of not greater than 100 is desirable. From the findings above, the relative permittivity of the discharge tube is desirably in the range of around 10 to 100, and more desirably in the range of 20 to 60.

### Relationship Between Frequency of High-Frequency Power Source for Plasma Generation (for Discharge) and Relative Permittivity of Discharge Tube

Here, the relationship between the frequency of the high-frequency power source for plasma generation and the relative permittivity of the discharge tube will be described. In general, the phase speed of an electromagnetic wave propagating in a medium having a relative permittivity of ε is given by Formula 1.

$$\frac{ω}{k} = \frac{c}{\sqrt{ɛ}} \qquad Formula 1$$

ω in Formula 1 represents the angular frequency of the electromagnetic wave, k represents the wave number of the electromagnetic wave and c represents the speed of light.

The relative permittivity of a cold collisionless plasma can be expressed by Formula 2.

$$ɛ = 1 - \frac{{ω}_{p}^{2}}{{ω}^{2}} \qquad Formula 2$$

ωₚ in Formula 2 is called the electrical plasma angular frequency, and is expressed by Formula 3.

$${ω}_{p} = \sqrt{\frac{{e}^{2} n}{{ɛ}_{0} m}} \qquad Formula 3$$

n in Formula 3 represents the electron density, and m represents the mass of an electron.

From Formula 2, the dispersion relation of the waves is expressed by Formula 4.

$$\frac{ω}{k} = \frac{c}{\sqrt{1 - \frac{{ω}_{p}^{2}}{{ω}^{2}}}} \qquad Formula 4$$

From Formula 4, in a low-density plasma where ωₚ²<<ω², then “ω/k” is approximately equal to the speed of light c. Furthermore, if ωₚ=ω, then k=0 and the wavelength is infinitely large. On the other hand, in a high-density plasma where ωₚ²>>ω², the wave number is a pure imaginary number, and therefore if k=i/δ (where i is an imaginary unit), the amplitude of the wave is expressed by exp(−δ/z) and attenuates with the depth z from the plasma surface.

This characteristic length δ is called the skin depth, and from Formula 3, can be expressed by Formula 5.

$$δ = \frac{c}{\sqrt{{ω}_{p}^{2} - {ω}^{2}}} \qquad Formula 5$$

At a sufficiently high density, when ωₚ²>>ω², then δ=c/ωₚ, and this is called the plasma skin thickness. For the purpose of simplicity, assumed is a surface wave propagating along the interface (z=0) when a uniform plasma is in contact with a semi-finite dielectric plate (relative permittivity ε_{d}). If the dispersion formula of the plasma (Formula 4) is rewritten by dividing the wave number k into a component kₓ along the interface, then Formula 6 is derived.

$${k}_{x} + {k}_{y} = \frac{{( \frac{ω}{c} )}^{2}}{( 1 - \frac{{ω}_{p}^{2}}{{ω}^{2}} )} \qquad Formula 6$$

If the density is high (ωₚ>>ω), then the right-hand side of Formula 6 will be negative. If the surface wave propagated in the x direction along the interface is considered (kₓ²>0), then to make the left-hand side of Formula 4 negative, k_{z}² should take a sufficiently large negative value, and therefore k_{z}=iα. In other words, the amplitude of the wave attenuates exponentially in the z direction. Similarly, in a dielectric body in which the solution (k_{z}=iβ) attenuates as the distance from the interface increases, looking at the boundary conditions where z=0 in relation to the magnetic field, ultimately, the surface wave dispersion relation shown in Formula 7 below is obtained.

$${k}_{x} = \frac{ω}{c} \sqrt{\frac{{ɛ}_{d} ( {ω}_{p}^{2} - {ω}^{2} )}{{ω}_{p}^{2} - ( 1 + {ɛ}_{d} ) {ω}^{2}}} \qquad Formula 7$$

ε_{d} in Formula 7 is the relative permittivity of the dielectric introduction window.

Since kₓ=∞ (resonance) when the denominator of the right-hand side of Formula 7 is 0, then surface wave resonance occurs when Formula 8 is satisfied.

ωₚ²=(1+ε_{d})ω² Formula 8

Formula 8 can be rewritten to obtain Formula 9.

$$ω = \frac{{ω}_{p}}{\sqrt{1 + {ɛ}_{d}}} \qquad Formula 9$$

Consequently, the right-hand side of Formula 9 has a real value in the case of a high-density plasma which satisfies Formula 10.

Nₑ=(1+ε_{d})N_{c} Formula 10

The electron density Nₑ shown in Formula 10 is called the “surface wave resonance density” and is represented by Nr. In a high-density plasma where the electron density is higher than N_{c}, the electromagnetic wave is reflected, the amplitude of the wave is attenuated dramatically in the z direction, and a surface wave propagating in the r−θ plane is excited. N_{c} in Formula 10 represents the cut-off density, and is expressed by Formula 11.

$${N}_{c} = \frac{{ɛ}_{0} {m}_{e} {ω}^{2}}{{e}^{2}} \qquad Formula 11$$

From Formula 11 and Formula 10, the surface wave resonance density can be expressed by Formula 12.

$${N}_{r} = \frac{( 1 + {ɛ}_{d} ) {ɛ}_{0} {m}_{e} {ω}^{2}}{{e}^{2}} \qquad Formula 12$$

As shown in Formula 12, the surface wave resonance density is determined by the relative permittivity ε_{d} of the discharge tube and the frequency f=ω/(2π) of the high-frequency power applied to the electrode wrapped about the discharge tube.

### Relationship Between Surface Wave Resonance Density and Etching Rate

In the experimental results described in FIG. 5, the surface wave resonance density when using a discharge tube of quartz (relative permittivity: 3.8) is 2.14×10⁸ cm⁻³, and in the case of a discharge tube of alumina (relative permittivity: 8.2), the surface wave resonance density is 4.10×10⁸ cm⁻³. On the other hand, the surface wave resonance density in the case of a high-permittivity discharge tube (relative permittivity: 45) is 2.05×10⁹ cm⁻³. This shows the following: the higher the surface wave resonance density, the faster the etching rate.

From the results in FIG. 5, in the case of alumina (relative permittivity: 8.2) which has a surface wave resonance density of 4.10×10⁸ cm⁻³, an etching rate some 2 to 3 times greater was obtained compared to quartz (surface wave resonance density=2.14×10⁸ cm⁻³, relative permittivity: 3.8). Moreover, an etching rate five times that of quartz was obtained with a high-permittivity material (permittivity: 45) having a surface wave resonance density of 2.05×10⁹ cm⁻³.

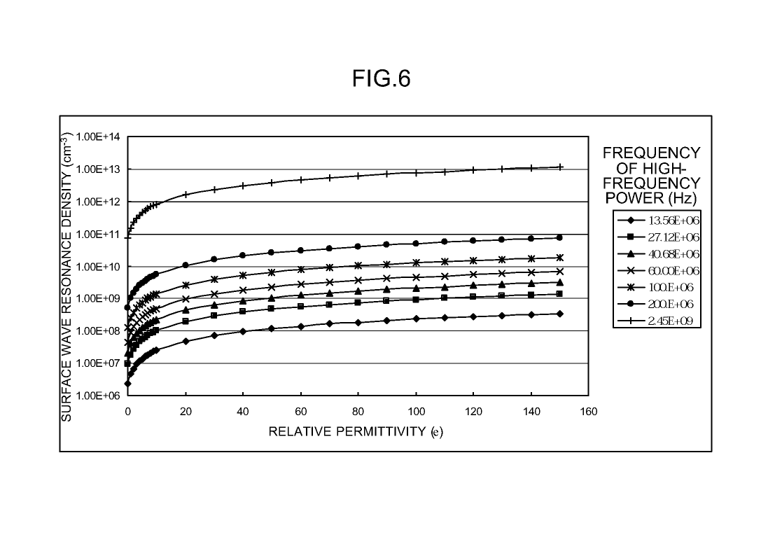

FIG. 6 shows the results of calculating the relationship between the relative permittivity of the discharge tube and the surface wave resonance density from Formula 12. The horizontal axis represents the relative permittivity and the vertical axis represents the surface wave resonance density. These results were calculated while changing the frequency of the high-frequency power for plasma generation in a range from 13.56×10⁶ Hz to 2.45×10⁹ Hz.

As shown in FIG. 6, when a microwave (2.45 GHz) is used for the high-frequency power, the surface wave resonance density is a high density of 1×10¹¹ cm⁻³ or above. In particular, by combining a microwave high-frequency power source and a high-permittivity discharge tube having a relative permittivity of 20 or greater, the surface wave resonance density is a high density of the order of 10¹² to 10¹³ (unit: cm⁻³).

However, if it is sought to maintain the plasma in these conditions, an extremely high microwave output (power) is required. A microwave power source is generally expensive, and based on a complicated system, and therefore this is a composition which it is difficult to adopt in practice.

In FIG. 6, looking in particular at other frequencies, even when a power source in the range of 13.56 MHz to 200 MHz is used, it is possible to achieve a relatively high surface wave resonance density with an upper limit of about 1.0×10¹¹ cm⁻³, by combining with the permittivity of the discharge tube.

If the etching rate when using an alumina discharge tube as illustrated in FIG. 5 is taken as the judgment criteria, then in FIG. 6, conditions where the surface wave resonance density is 4.1×10⁸ cm⁻³ or above are desirable. In other words, provided that the surface wave resonance density is not less than 4.1×10⁸ cm⁻³ and not greater than 1.0×10¹¹ cm⁻³, there are no particular restrictions on the specific numerical combination of the relative permittivity of the discharge tube and the frequency of the plasma generation high-frequency power.

By adopting an apparatus composition which satisfies these conditions for the surface wave resonance density, it is possible to generate a surface wave plasma having a sufficiently high surface wave resonance density, without using a high-frequency power source for microwaves, and therefore the apparatus can be simplified and the apparatus costs can be reduced.

Furthermore, by adopting a composition which simultaneously satisfies the stated conditions for the surface wave resonance density and the aforementioned desirable numerical range for the relative permittivity (10 to 100, and more desirably, 20 to 60), then it is possible to achieve yet further improvements in reliability.

### Countermeasure for Particles

Since the discharge tube 30 is exposed to plasma, there is a problem of generation of particles. In view of this problem, it is possible to suppress the occurrence of particles by coating the inner surfaces of the discharge tube 30 with a film containing fluorine groups. For such a fluorine coating method, a fluorine coating can be applied by plasma processing using a gas containing fluorine. Apart from this, it is also possible to provide a fluorine coating by sputtering, vapor deposition, CVD, or the like.

### Second Embodiment

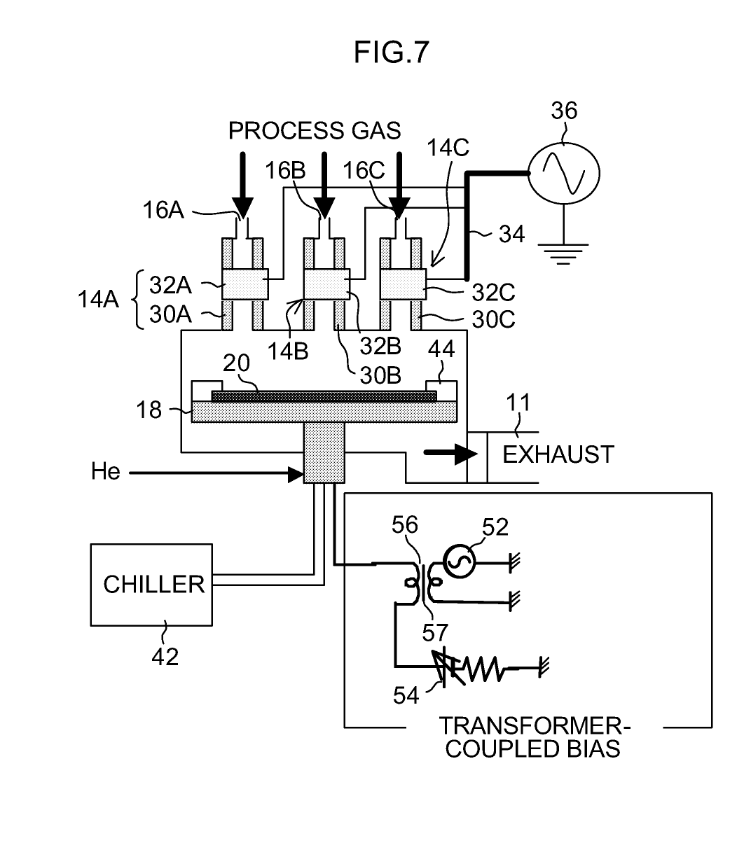

FIG. 7 is a schematic drawing of a dry etching apparatus 100 relating to a second embodiment of the present invention. In FIG. 7, members which are the same as or similar to members shown in FIG. 1 are labeled with the same reference numerals and further explanation thereof is omitted here.

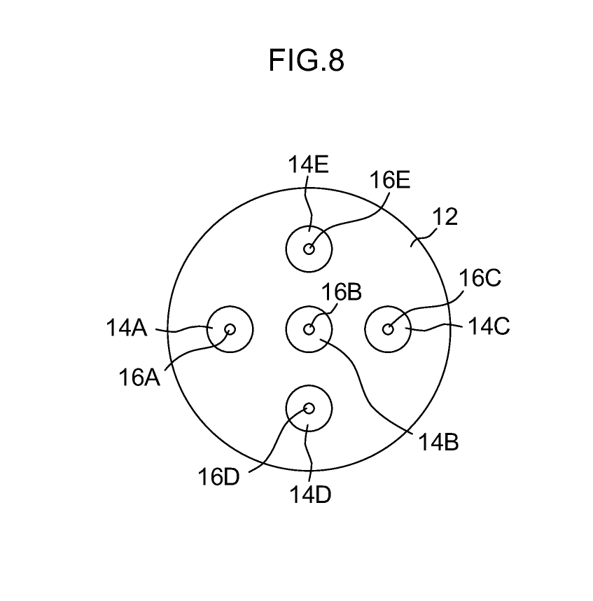

The dry etching apparatus 100 shown in FIG. 7 is an example corresponding a larger size of the substrate, and a plurality of plasma sources 14A, 14B, 14C, . . . are provided with the vacuum chamber 12. FIG. 8 is a plan diagram of a dry etching apparatus 100 viewed from above.

In the dry etching apparatus 100 shown in FIG. 8, five plasma sources 14A to 14E are installed in the upper portion of the vacuum chamber 12 (see FIG. 8), but there are no particular restrictions on the number of plasma sources installed or the arrangement mode thereof. The plasma sources 14A to 14E have a similar structure to that of the plasma source 14 shown in FIG. 1.

More specifically, round cylindrical discharge tubes 30A to 30E respectively have process gas introduction ports 16A to 16E, and a high-frequency power for plasma generation is applied from the high-frequency power source 36 to band-shaped mesh electrodes 32A to 32E which are wrapped about the outer circumferential portions of the respective discharge tubes 30A to 30E respectively.

The discharge tubes 30A to 30E are provided extending in a direction perpendicular to the surface of the substrate 20, and by adopting a structure in which the plurality of discharge tubes 30A to 30E are arranged symmetrically about the center of the substrate 20 being processed, it is possible to generate a uniform plasma even with a substrate of large size (for example, a substrate having a diameter of 8 inches or greater).

### Third Embodiment

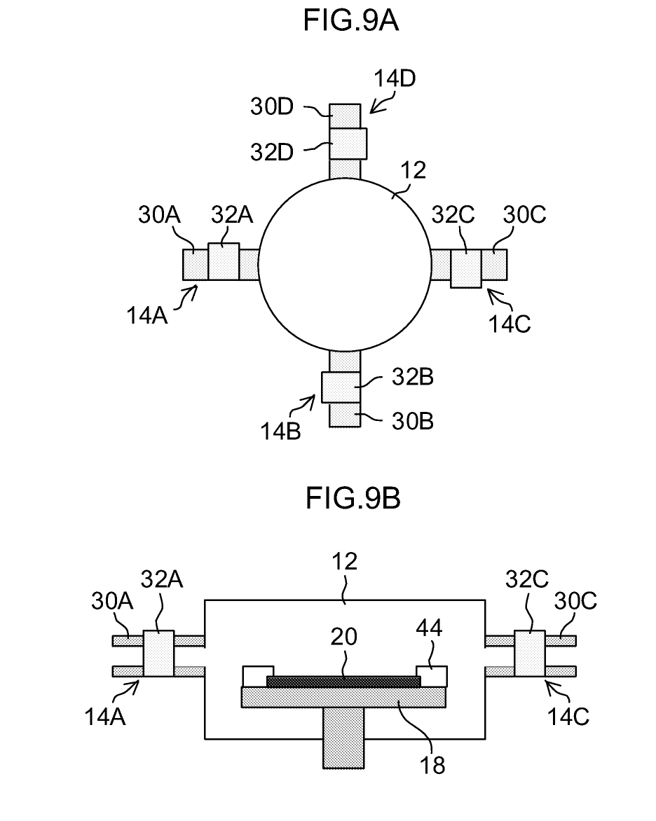

FIGS. 9A and 9B are principal schematic drawings of a dry etching apparatus 110 relating to a third embodiment of the present invention. FIG. 9A is a top diagram and FIG. 9B is a cross-sectional diagram. In FIGS. 9A and 9B, members which are the same as or similar to members shown in FIG. 1 and FIGS. 7 and 8 are labeled with the same reference numerals and further explanation thereof is omitted here.

The dry etching apparatus 110 shown in FIGS. 9A and 9B is a further example corresponding to a larger size of substrate, and adopts a composition in which discharge tubes 30A to 30D are provided in a horizontal direction with respect to the substrate 20, on the side face portions of the vacuum chamber 12. Here, an example is given in which four discharge tubes 30A to 30D are installed, but the number of discharge tubes and their arrangement modes are not limited in particular.

### Fourth Embodiment

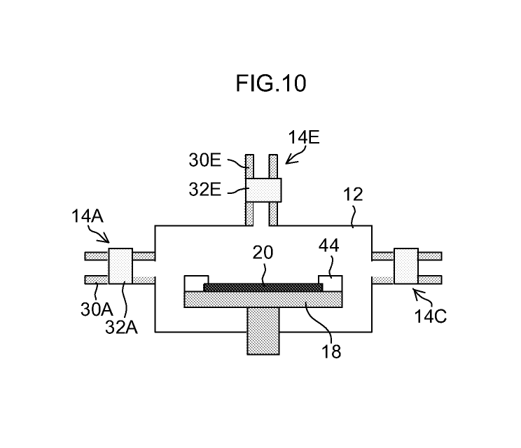

FIG. 10 is a principal schematic drawing of a dry etching apparatus 120 relating to a fourth embodiment of the present invention. In FIG. 10, members which are the same as or similar to members shown in FIG. 1 and FIGS. 7 and 8 are labeled with the same reference numerals and further explanation thereof is omitted here.

The dry etching apparatus 120 shown in FIG. 10 is an example which combines the mode described in the first embodiment (FIG. 1) or the second embodiment (FIGS. 7 to 8) (a mode where discharge tubes are provided in a perpendicular direction with respect to the substrate), with the mode described in the third embodiment (FIGS. 9A and 9B) (a mode where discharge tubes are provided in a horizontal direction parallel to the substrate). By means of this mode, it is possible to generate a uniform plasma which is sufficiently compatible with a larger size of substrate.

### BENEFICIAL EFFECTS OF EMBODIMENTS OF THE PRESENT INVENTION

The embodiments described above each have technical benefits of the following kind.

(1) Continuous negative ion generation is possible by using a downstream region of the surface wave plasma.
(2) By using a high-frequency power source having a frequency in the VHF band (30 MHz to 300 MHz), it is possible to obtain a high surface wave resonance density (for example, not less than 4.1×10⁸ cm⁻³ and not greater than 1.0×10¹¹ cm⁻³) even with a discharge tube having a relatively low permittivity (FIG. 6), and therefore a high density of negative ions can be generated by means of a high-density plasma. Furthermore, compared to a conventional microwave plasma apparatus, it is possible to simplify the apparatus and reduce the costs.
(3) By adopting a composition in which a direct current (DC) voltage from a DC power source 54 and a high-frequency (RF) voltage from a high-frequency power source 52 are superimposed in a transformer coupling method and are applied to a stage 18 which supports a substrate 20, it is possible to control Vdc and Vpp independently.
(4) By applying a positive bias to the substrate 20 by means of the composition in (3) above, it is possible to attract negative ions efficiently into the substrate 20, and it is possible to process (etch) even etching resistant materials at high speed, due to the reactivity of the negative ions.
(5) Furthermore, according to an embodiment of the present invention, it is possible to perform anisotropic processing and therefore a good processing shape, such as a shape which is free of deposit film (film adhering to the side walls), can be obtained.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A dry etching method comprising the steps of:
supplying process gas to an interior of a vacuum vessel and supplying high-frequency power for plasma generation to an electrode of a plasma generation unit disposed in the vacuum vessel so as to generate plasma; and
applying a high-frequency bias voltage to a substrate which is a member to be etched so as to carry out etching of the substrate,
wherein the etching is carried out while applying the high-frequency bias voltage in which a self-bias voltage Vdc of a substrate bias voltage is not less than 0 Volts, by adopting a composition using a high-frequency power source for bias which is transformer-coupled to the substrate and a direct current power source for bias which is connected in series to a secondary side of a transformer so as to apply the substrate bias voltage in which a high-frequency voltage and a direct current voltage are superimposed, to the substrate from these power sources via the transformer.

2. The dry etching method as defined in claim 1, wherein the plasma generation unit generates surface wave plasma.

3. The dry etching method as defined in claim 1, wherein the process gas contains a halogen.

4. The dry etching method as defined in claim 1, wherein the member to be etched is a ferroelectric body, a precious metal, or a magnetic body.

5. A dry etching apparatus comprising:
a vacuum vessel;
a gas supply port for supplying process gas into the vacuum vessel;
a plasma generation unit provided in the vacuum vessel;
a high-frequency power source for plasma generation which supplies high-frequency power for plasma generation to an electrode of the plasma generation unit;
a stage which is provided inside the vacuum vessel and holds a substrate which is a member to be etched;
a high-frequency power source for bias which is transformer-coupled to the stage; and
a direct current power source for bias which is connected in series to a secondary side of a transformer to which the high-frequency power source for bias is connected,
wherein a substrate bias voltage in which a high-frequency voltage and a direct current voltage are superimposed is applied to the stage from the high-frequency power source for bias and the direct current power source for bias, via the transformer.

6. The dry etching apparatus as defined in claim 5, wherein a self-bias voltage Vdc of the substrate bias voltage is not less than 0 Volts.

7. The dry etching apparatus as defined in claim 5, wherein the plasma generation unit generates surface wave plasma.

8. The dry etching apparatus as defined in claim 7, wherein a surface wave resonance density of the surface wave plasma generated by the plasma generation unit is not less than 4.1×10⁸ cm⁻³ and not greater than 1.0×10¹¹ cm⁻³.

9. The dry etching apparatus as defined in claim 5, wherein a frequency of the high-frequency power for plasma generation is in a range of 27 MHz to 200 MHz.

10. The dry etching apparatus as defined in claim 5, wherein the plasma generation unit has a configuration in which the electrode is disposed on an outer circumferential portion of a dielectric member.

11. The dry etching apparatus as defined in claim 10, wherein a relative permittivity of the dielectric member is in a range of 10 to 100.

12. The dry etching apparatus as defined in claim 10, wherein the dielectric member is a round cylindrical discharge tube.

13. The dry etching apparatus as defined in claim 12, wherein a plurality of said round cylindrical plasma generation units are provided in the vacuum vessel.

14. The dry etching apparatus as defined in claim 13, wherein the plurality of round cylindrical plasma generation units are provided extending in a direction perpendicular to the substrate.

15. The dry etching apparatus as defined in claim 13, wherein the plurality of round cylindrical plasma generation units are provided extending in a horizontal direction parallel to the substrate.

16. The dry etching apparatus as defined in claim 13, wherein a portion of the plurality of plasma generation units is provided extending in a direction perpendicular to the substrate and another portion of the plurality of plasma generation units is provided extending in a horizontal direction parallel to the substrate.

17. The dry etching apparatus as defined in claim 5, wherein an inner surface of the dielectric member is covered with a film containing a fluorine group.
